(19) United States
(12) Patent Application Publication
(10) Pub. No.: US 2026/0350448 A1
(43) Pub. Date: Nov. 5, 2026

(54) QUANTUM QUEUE OPTIMIZATION FOR ERROR MITIGATION

(71) Applicant: INTERNATIONAL BUSINESS MACHINES CORPORATION, ARMONK, NY (US)

(72) Inventors: Ana Paula Appel, São Paulo (BR); Daniel Josef Egger, Zurich (CH); Kaelyn Jae Ferris, Athens, OH (US); Sanjay Kumar Lalta Prasad Vishwakarma, Sunnyvale, CA (US); Razvan Paul Sebastian BRANDHOFER, Boeblingen (DE)

(21) Appl. No.: 19/198,623

(22) Filed: May 5, 2025

(51) Int. Cl. G06N 10/20; G06N 10/40; G06N 10/70

(52) U.S. Cl. CPC G06N 10/20; G06N 10/40; G06N 10/70

(57) ABSTRACT

In an approach to improve quantum computing systems embodiments receive a plurality of quantum circuits and determine a noise model for each of the plurality of quantum circuits. Further, embodiments execute a portion of the plurality of quantum circuits concurrently based on the noise model for each of the plurality of quantum circuits.

### BACKGROUND OF THE INVENTION

The present invention relates generally to a method, system, and computer program product for using quantum computing systems. More particularly, the present invention relates to a method, system, and computer program product for maximizing the utilization and efficiency of quantum computing.

A quantum processing unit (QPU) is the computational component of a quantum computer. It is where the qubits reside, and where algorithms are performed to achieve results. Like the central processing unit, or CPU, of a classical computer, a QPU requires supporting infrastructure to operate, such as control electronics, that enable single and double gate operations amongst the qubits which are needed for quantum computations. A quantum computer is a computer that exploits quantum mechanical phenomena to perform quantum computations. On small scales, physical matter exhibits properties of both particles and waves, and quantum computing leverages this behavior using specialized hardware.

The field of quantum computing contains a range of disciplines, including quantum hardware and quantum algorithms. By taking advantage of quantum physics, fully realized quantum computers would be able to process massively complicated problems at orders of magnitude faster than modern machines. For a quantum computer, challenges that might take a classical computer thousands of years to complete might be reduced to a matter of minutes. Currently, quantum computing architectures execute jobs sequentially, resulting in underutilization of resources and increased processing times. This limitation is particularly pronounced when tackling complex problems that require error mitigation. A solution that minimizes the cost of executing error mitigation in a queue-based quantum computer would greatly enhance the throughput of our quantum computers. Efficient resource utilization is needed to unlock the full potential of quantum processing.

### SUMMARY

Embodiments of the present invention disclose a method, a computer program product, and a system, the method comprising: receiving a plurality of quantum circuits; determining a noise model for each of the plurality of quantum circuits; and executing a portion of the plurality of quantum circuits concurrently based on the noise model for each of the plurality of quantum circuits.

Embodiments further disclose merging two or more quantum computing jobs (jobs) in a queue, wherein the merging of the two or more jobs comprises determining that the two or more jobs in the queue can merge based on the size of the queue and a cache of learned layers. Embodiments further disclose scanning a queue of jobs in a quantum computing system to identify circuits that can be merged to minimize resulting noise layers to learn or match the noise layers with those that are in a cache of learned layers. Embodiments further disclose compiling a list of jobs in a job queue that can potentially be merged together. Embodiments further disclose performing result distribution of an output result. Embodiments further disclose creating an empty circuit, selecting a job in a queue; and performing a string search to identify where a bitstring

$$( {b}_{i}^{j} )$$

is contained in layers of active cache.

### BRIEF DESCRIPTION OF THE DRAWINGS

FIG. 1 is a functional block diagram illustrating a distributed data processing environment, executing quantum queue optimization program, in accordance with an embodiment of the present invention;

FIG. 2A is a functional block diagram illustrating a distributed data processing environment, executing the quantum queue optimization program, in accordance with an embodiment of the present invention;

FIG. 2B is a functional block diagram illustrating a distributed data processing environment, executing the quantum queue optimization program, in accordance with an embodiment of the present invention;

FIG. 3 illustrates a block diagram illustrating a distributed data process environment, executing the quantum queue optimization program, on a server computer within the distributed data processing environment of FIG. 1 and FIG. 2B, in accordance with an embodiment of the present invention;

FIG. 4 illustrates an example of queue optimization in accordance with an embodiment of the present invention;

FIG. 5 illustrates operational steps of the quantum queue optimization program, on a server computer within the distributed data processing environment of FIG. 1 and FIG. 2B, in accordance with an embodiment of the present invention;

FIG. 6 illustrates an example of queue optimization by job merging in accordance with an embodiment of the present invention;

FIG. 7 illustrates operational steps of the quantum queue optimization program, on a server computer within the distributed data processing environment of FIG. 1 and FIG. 2B, in accordance with an embodiment of the present invention; and

FIG. 8 illustrates an example of queue optimization through space merging in accordance with an embodiment of the present invention.

### DETAILED DESCRIPTION

According to an aspect of the invention, there is a provided method, computer system, and computer program product to receive a plurality of quantum circuits, determine a noise model for each of the plurality of quantum circuits, and execute a portion of the plurality of quantum circuits concurrently based on the noise model for each of the plurality of quantum circuits. The entire aspect of the invention, detailed above, might cause improved utilization and efficiency of quantum computing by efficiently utilizing qubits in a quantum system to merge two or more quantum computing jobs.

According to an aspect of the invention, the provided method, computer system, and computer program product may further comprise merging two or more jobs in a queue, wherein the merging of the two or more jobs comprises determining that the two or more jobs in the queue can merge based on the size of the queue and a cache of learned layers. In embodiments, the merging of two or more jobs in a queue, wherein the merging of the two or more jobs comprises determining that the two or more jobs in the queue can merge based on the size of the queue and a cache of learned layers, at least, advantageously increases the efficiency and utilization of a quantum computing system.

According to an aspect of the invention, the provided computer-implemented method, computer system, and computer program product may further comprise scanning a queue of jobs in a quantum computing system to identify circuits that can be merged to minimize resulting noise layers to learn or match the noise layers with those that are in a cache of learned layers. In embodiments, the scanning a queue of jobs in a quantum computing system to identify circuits that can be merged, at least, advantageously improves the resource utilization in quantum processing.

According to an aspect of the invention, the provided computer-implemented method, computer system, and computer program product may further comprise compiling a list of jobs in a job queue that can potentially be merged together. In embodiments, the compiling of a list jobs that can potentially be merged, at least, advantageously improves the resource utilization in quantum processing.

According to an aspect of the invention, the provided computer-implemented method, computer system, and computer program product may further comprise performing result distribution of an output result. In embodiments, performing result distribution of an output result, at least, advantageously improves quantum queue optimization through error mitigation.

According to an aspect of the invention, the provided computer-implemented method, computer system, and computer program product may further comprise creating an empty circuit, selecting a job in a queue, and performing a string search to identify where a bitstring is contained in layers of active cache. In embodiments, creating an empty circuit, selecting a job in a queue, and performing a string search to identify where a bitstring is contained in layers of active cache, at least, advantageously improves the efficiency and utilization of a quantum computing system.

Embodiments recognize that quantum computing resources are scarce and costly. Embodiments recognize that the path to error corrected quantum processors will become large and expensive. However, until true quantum error correction (QEC) is achieved, there will be quantum processing units (QPUs) with more qubits than a single user will need to run a noisy application. Embodiments recognize that if a QPU only runs a single user at a time then the QPU will have a very low throughput and therefore be inefficient. This issue is compounded by error mitigation which requires learning the noise model of layers of gates. Thus, there is a need in the art for multi-tenant QPUs (MT-QPU) where multiple users simultaneously execute programs on the QPU with job execution optimized for error mitigation. Challenges associated with MT-QPUs comprise, but are not limited to, cross-talk and interference between the programs executed, information leakage and vulnerabilities, and job scheduling challenges (e.g., (i) different number of qubits, (ii) different gate layers to learn, and (iii) different number of shots).

Embodiments recognize that achieving simultaneous job execution in quantum computing with error mitigation poses significant technical challenges, including managing the overhead of error mitigation, mitigating cross-talk between jobs, keeping job execution secure, and optimizing resource allocation, thereby creating a need for innovative solutions to overcome these hurdles. By executing multiple jobs simultaneously, quantum computing systems can significantly improve resource utilization, increase throughput, and reduce processing times. The execution of multiple jobs simultaneously enables the solution of more complex problems and the acceleration of the development of quantum computing applications.

Embodiments solve at least the issues stated above by developing innovative solutions to execute multiple jobs simultaneously, to improve resource utilization, increase throughput, and reduce processing times, ultimately driving innovation. Embodiments improve the art and solve at least the issues stated above by minimizing the cost of executing error mitigation in a queue-based quantum computer and enhancing the throughput of quantum computers by merging jobs in a quantum system job queue for error mitigation while considering space-like and time-like circuit merging, user constraints, and job execution consistency, to enable seamless and secure multi-tenant circuit operation. By offering users incentives embodiments encourage the sharing of resources, leading to increased throughput and reduced processing times.

Embodiments improve the current art and solve at least the issues stated above through a quantum queue optimizer that addresses challenges in quantum computing, providing non-obvious benefits such as improved resource utilization and increased flexibility. By merging jobs in the queue while considering multiple factors, embodiments optimize job execution and resource allocation, offering users price rebates for allowing multi-tenant circuit operation. Further, embodiments improve the art and solve the particular issues stated above by executing time-like job merging, varying shot numbers, and implementing error mitigation aspects to quantum queue optimization.

In various embodiments, cross-talk refers to the unwanted interactions or interference between two or more quantum circuits, quantum bits (qubits), or quantum gates executed simultaneously or near one another. Cross-talk arises due to, e.g., electromagnetic interference, quantum noise, or the shared use of common resources such as quantum buses or control lines. Cross-talk causes errors in the execution of quantum algorithms, reduces fidelity, increases error rates, and decreases overall performance of the quantum computing system. Cross-talk can manifest as unwanted phase shifts, bit flips, or entanglement between qubits.

In various embodiments, multi-tenant quantum processing units (QPUs) refers to multiple users simultaneously executing their circuits on a quantum processing unit (QPU).

In various embodiments, transpilation in quantum computing involves converting a high-level quantum circuit into a lower-level representation that can be executed on actual quantum hardware.

In various embodiments, error mitigation refers to the noise model of layers of hardware native qubit gates is learnt and then used to post-process the results obtained from the execution of quantum circuits.

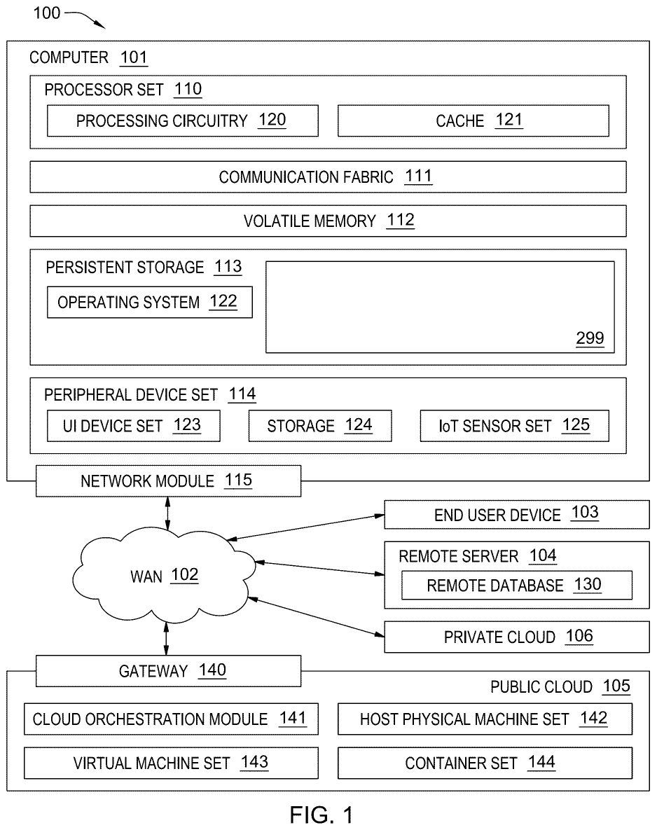

Implementation of embodiments of the invention may take a variety of forms, and exemplary implementation details are discussed subsequently with reference to the Figures (i.e., FIG. 1-FIG. 8).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as quantum queue optimization program (component) 299. In addition to component 299, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and component 299, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

In various embodiments, component 299 optimizes the execution of quantum jobs based on reducing the overhead of error mitigation. In various embodiments, component 299 executes multiple quantum jobs (jobs) simultaneously which improves resource utilization, increase throughput, and reduce processing times in quantum computing systems. The execution of multiple jobs simultaneously enables the solution of more complex problems and the acceleration of the development of quantum computing applications.

In various embodiments, component 299 solves at lease this issue by developing innovative solutions to execute multiple jobs simultaneously, to improve resource utilization, increase throughput, and reduce processing times, ultimately driving innovation. Component 299 improves the art by minimizing the computational cost of executing error mitigation in a queue-based quantum computer and enhancing the throughput of quantum computers by merging jobs in the queue for error mitigation while considering space-like and time-like circuit merging, user constraints, and job execution consistency, to enable seamless and secure multi-tenant circuit operation.

In various embodiments, component 299 addresses complex challenges in quantum computing, providing non-obvious benefits such as improved resource utilization and increased flexibility. By merging jobs in the queue while considering multiple factors, component 299 optimizes job execution and resource allocation, offering users price rebates for allowing multi-tenant circuit operation. Further, component 299 improves the art and solve the particular issues stated above by executing time-like job merging, varying shot numbers, and implementing error mitigation aspects to quantum queue optimization.

In various embodiments, component 299 scans a queue of jobs in a quantum computing system to identify circuits that can be merged to minimize the resulting noise layers to learn and/or matches the noise layers with those that are in the cache of learned layers.

COMPUTER 101 may take the form of a desktop computer, laptop computer, tablet computer, smart phone, smart watch or other wearable computer, mainframe computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in component 299 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in component 299 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

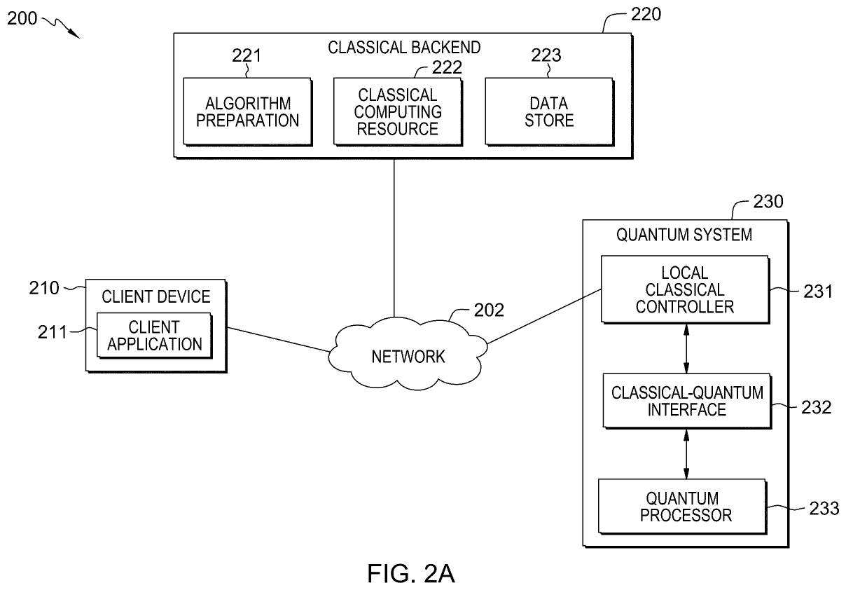

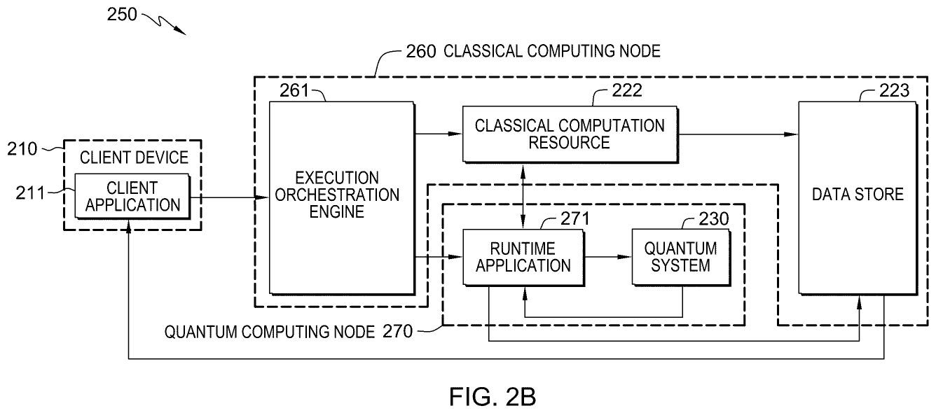

FIG. 2A illustrates a block diagram of an example hybrid computing system 200 that can facilitate execution of a quantum algorithm. As shown, a client device 210 may interface with a classical backend 220 to enable computations with the aid of a quantum system 230.

Network 202 may be any combination of connections and protocols that will support communications between the client device 210, the classical backend 220, and the quantum system 230. In an example embodiment, network 202 may WAN 102.

Client device 210 may be an implementation of computer 101 or EUD 103, described in more detail with reference to FIG. 1, configured to operate in a hybrid computing system 200.

Client application 211 may include an application or program code that includes computations requiring a quantum algorithm or quantum operation. In an embodiment, client application 211 may include an object-oriented programming language, such as Python® (“Python” is a registered trademark of the Python Software Foundation), capable of using programming libraries or modules containing quantum computing commands or algorithms, such as QISKIT (“QISKIT” is a registered trademark of the International Business Machines Corporation). In another embodiment, client application 211 may include machine level instructions for performing a quantum circuit, such as OpenQASM. Additionally, user application may be any other high-level interface, such as a graphical user interface, having the underlying object oriented and/or machine level code as described above.

The classical backend 220 may be an implementation of computer 101, described in more detail with reference to FIG. 1, having program modules configured to operate in a hybrid computing system 200. Such program modules for classical backend 220 may include algorithm preparation 221, classical computing resource (e.g., classical computation) 222, and data store 223.

Algorithm preparation 221 may be a program or module capable of preparing algorithms contained in client application 211 for operation on quantum system 230. Algorithm preparation 221 may be instantiated as part of a larger algorithm, such as a function call of an API, or by parsing a hybrid classical-quantum computation into aspects for quantum and classical calculation. Algorithm preparation 221 may additionally compile or transpile quantum circuits that were contained in client application 211 into an assembly language code for use by the local classical controller 231 to enable the quantum processor 233 to perform the logical operations of the circuit on physical structures. During transpilation/compilation an executable quantum circuit in the quantum assembly language may be created based on the calculations to be performed, the data to be analyzed, and the available quantum hardware. In one example embodiment, algorithm preparation 221 may select a quantum circuit from a library of circuits that have been designed for use in a particular problem. In another example embodiment, algorithm preparation 221 may receive a quantum circuit from the client application 211 and may perform transformations on the quantum circuit to make the circuit more efficient, or to fit the quantum circuit to available architecture of the quantum processor 233. Additionally, algorithm preparation 221 may prepare classical data from data store 223, or client application 211, as part of the assembly language code for implementing the quantum circuit by the local classical controller 231. Algorithm preparation 221 may additionally set the number of shots (i.e., one complete execution of a quantum circuit) for each circuit to achieve a robust result of the operation of the algorithm. Further, algorithm preparation 221 may update, or re-compile/re-transpile, the assembly language code based on parallel operations occurring in classical computing resource 222 or results received during execution of the quantum calculation on quantum system 230. Additionally, algorithm preparation 221 may determine the criterion for convergence of the quantum algorithm or hybrid algorithm.

Error Suppression/Mitigation may be a program or module capable of performing error suppression or mitigation techniques for improving the reliability of results of quantum computations. Error suppression is the most basic level of error handling. Error suppression refers to techniques where knowledge about the undesirable effects of quantum hardware is used to introduce customization that can anticipate and avoid the potential impacts of those effects, such as modifying signals from Classical-quantum interface 232 based on the undesirable effects. Error mitigation uses the outputs of ensembles of circuits to reduce or eliminate the effect of noise in estimating expectation values. Error mitigation may include techniques such as Zero Noise Extrapolation (ZNE) and Probabilistic Error Correction (PEC).

Classical computing resource 222 may be a program or module capable of performing classical (e.g., binary, digital) calculations contained in client application 211. Classical calculations may include formal logical decisions, AI/ML algorithms, floating point operations, and/or simulation of Quantum operations.

Data store 223 may be a repository for data to be analyzed using a quantum computing algorithm, as well as the results of such analysis. Data store 223 may be an implementation of storage 124 and/or remote database 130, described in more detail with reference to FIG. 1, configured to operate in a hybrid computing system 200.

The quantum system 230 can be any suitable set of components capable of performing quantum operations on a physical system. In the example embodiment depicted in FIG. 2A, quantum system 230 includes a local classical controller 231, a classical-quantum interface 232, and quantum processor 233. In some embodiments, all or part of each of the local classical controller 231, a classical-quantum interface 232, and quantum processor 233 may be located in a cryogenic environment to aid in the performance of the quantum operations. In an embodiment, classical backend 220 and quantum system 230 may be co-located to reduce the communication latency between the devices. Quantum system 230 may be any combination of control and qubit architectures to implement quantum computations, where logical qubits for logical operations can be single qubits or multiple qubits (e.g., a logical qubit as part of an error correcting code).

Local classical controller 231 may be any combination of classical computing components capable of aiding a quantum computation, such as executing one or more quantum operations to form a quantum circuit, performing error-correction on logical qubits, or any other local classical computation, by providing commands to a classical-quantum interface 232 as to the type and order of signals to provide to the quantum processor 233. Local classical controller 231 may additionally perform other low/no latency functions, such as error correction, to enable efficient quantum computations. Such digital computing devices may include processors and memory for storing and executing quantum commands using classical-quantum interface 232. Additionally, such digital computing devices may include devices having communication protocols for receiving such commands and sending results of the performed quantum computations to classical backend 220. Additionally, the digital computing devices may include communications interfaces with the classical-quantum interface 232. In an embodiment, local classical controller 231 may include all components of computer 101, or alternatively may be individual components configured for specific quantum computing functionality, such as processor set 110, communication fabric 111, volatile memory 112, persistent storage 113, and network module 115.

Classical-quantum interface 232 may be any combination of devices capable of receiving command signals from local classical controller 231 and converting those signals into a format for performing quantum operations on the quantum processor 233. Such signals may include electrical (e.g., RF, microwave, DC), optical signals, magnetic signals, or vibrational signals to perform one or more single qubit operations (e.g., Pauli gate, Hadamard gate, Phase gate, Identity gate), signals to preform multi-qubit operations (e.g., CNOT-gate, CZ-gate, SWAP gate, Toffoli gate), qubit state readout signals, and any other signals that might enable quantum calculations, quantum error correction, and initiate the readout of a state of a qubit. Additionally, classical-quantum interface 232 may be capable of converting signals received from the quantum processor 233 into digital signals capable of processing and transmitting by local classical controller 231 and classical backend 220. Such signals may include qubit state readouts. Devices included in classical-quantum interface 232 may include, but are not limited to, digital-to-analog converters, analog-to-digital converters, waveform generators, attenuators, amplifiers, filters, optical fibers, and lasers.

Quantum processor 233 may be any hardware capable of using quantum states to process information. Such hardware may include a collection of qubits, mechanisms to couple/entangle the qubits, and any required signal routings to communicate between qubits or with classical-quantum interface 232 in order to process information using the quantum states. Such qubits may include, but are not limited to, charge qubits, flux qubits, phase qubits, spin qubits, and trapped ion qubits, or any other suitable qubit structures. The architecture of quantum processor 233, such as the arrangement of data qubits, error correcting qubits, and the couplings amongst them, may be a consideration in performing a quantum circuit on quantum processor 233.

Referring now to FIG. 2B, a block diagram is depicted showing an example architecture, and data transmission, of hybrid computation system 250 employed using a cloud architecture for classical backend 220. Hybrid computation system 250 receives an algorithm containing a computation from a client application 211 of client device 210. Upon receipt of the algorithm and request from client application 211, hybrid computation system 250 instantiates a classical computing node 260 and a quantum computing node 270 to manage the parallel computations. The classical computing node 260 may include one or more classical computers capable of working in tandem (e.g., utilizing the cloud computing environment described with reference to FIGS. 1 and 2A). For example, classical computing node 260 may include an execution orchestration engine 261, one or more classical computation resources 222, and a result data store 223. The backend quantum runtime application 271 may include a combination of classical and quantum computing components acting together to perform quantum calculations on quantum hardware including, for example, one or more quantum systems 230. The quantum computing node 270 may include a quantum runtime application 271 and one or more quantum systems 230.

The client application 211 may include programing instructions to perform quantum and classical calculations. In an embodiment, client application 211 may be in a general-purpose computing language, such as an object-oriented computing language (e.g., Python®), that may include classical and quantum functions and function calls. This may enable developers to operate in environments they are comfortable with, thereby enabling a lower barrier of adoption for quantum computation.

The execution orchestration engine 261, in using algorithm preparation 221, may parse the client application 211 into a quantum logic/operations portion for implementation on a quantum computing node 270, and a classical logic/operations portion for implementation on a classical node 260 using a classical computation resource 222. In an embodiment, parsing the client application 211 may include performing one or more data processing steps prior to operating the quantum logic using the processed data. In an embodiment, parsing the client application 211 may including segmenting a quantum circuit into portions that are capable of being processed by quantum computing node 270, in which the partial results of each of the segmented quantum circuits may be recombined as a result to the quantum circuit. Execution orchestration engine 261 may parse the hybrid algorithm such that a portion of the algorithm is performed using classical computation resources 223 and a session of quantum computing node 270 may open to perform a portion of the algorithm. Quantum runtime application 271 may communicate, directly or indirectly, with classical computation resources 223 by sending parameters/information between the session to perform parallel calculations and generate/update instructions of quantum assembly language to operate quantum system 230, and receiving parameters/information/results from the session on the quantum system 230. Following the parsing of the hybrid algorithm for calculation on quantum computing node 270 and classical computing node 260, the parallel nodes may iterate the session to convergence by passing the results of quantum circuits, or partial quantum circuits, performed on quantum system 230 to classical computing resource 222 for further calculations. Additionally, quantum runtime application 271, using algorithm preparation 221, may re-parse aspects of the hybrid algorithm to improve convergence or accuracy of the result. Such operation results, and progress of convergence, may be sent back to client device 210 as the operations are being performed. By operating execution orchestration engine 261 in a cloud environment, the environment may scale (e.g., use additional computers to perform operations necessary) as required by the client application 211 without any input from the creators/implementors of client application 211. Additionally, execution orchestration engine 261, while parsing the client application 211 into classical and quantum operations, may generate parameters, function calls, or other mechanisms in which classical computation resource 222 and quantum computing node 270 may pass information (e.g., data, commands) between the components such that the performance of the computations enabled by client application 211 is efficient.

Classical computation resources 222 may perform classical computations (e.g., formal logical decisions, AI/ML algorithms, floating point operations, simulation of Quantum operations) that aid/enable/parallelize the computations instructed by client application 211. By utilizing classical computation resources 223 in an adaptively scalable environment, such as a cloud environment, the environment may scale (e.g., use additional computers to perform operations necessary including adding more classical computation resources 223, additional quantum systems 230, and/or additional resources of quantum systems 230 within a given quantum computing node 270) as required by the client application 211 without any input from the creators/implementors/developers of client application 211, and may appear seamless to any individual implementing client application 211 as there are no required programming instructions in client application 211 needed to adapt to the classical computation resources 223. Thus, for example, such scaling of quantum computing resources and classical computing resources may be provided as needed without user intervention. Scaling may reduce the idle time, and thus reduce capacity and management of computers in classical computing node 260.

Result data store 223 may store, and return to client device 210, states, configuration data, etc., as well as the results of the computations of the client application 211.

Implementation of the systems described herein may enable hybrid computing system 200, through the use of quantum system 230, to process information, or solve problems, in a manner not previously capable. The efficient parsing of the quantum or hybrid algorithm into classical and quantum segments for calculation may achieve efficient and accurate quantum calculations from the quantum system 230 for problems that are exponentially difficult to perform using classical backend 220. Additionally, the quantum assembly language created by classical backend 220 may enable quantum system 230 to use quantum states to perform calculations that are not classically efficient or accurate. Specifically, optimizing the execution of quantum jobs based on reducing the overhead of error mitigation. In various embodiments, component 299 executes multiple quantum jobs (jobs) simultaneously which improves resource utilization, increases throughput, and reduces processing times in quantum system 230. The execution of multiple jobs simultaneously enables the solution of more complex problems and the acceleration of the development of quantum computing applications. In various embodiments, component 299 improves quantum system 230 by minimizing the cost of executing error mitigation in a queue-based quantum computer and enhancing the throughput of quantum computers by merging jobs in the queue for error mitigation while considering space-like and time-like circuit merging, user constraints, and job execution consistency, to enable seamless and secure multi-tenant circuit operation. Improvements to quantum system addresses complex challenges in quantum computing, providing non-obvious benefits such as improved resource utilization and increased flexibility. By merging jobs in the queue while considering multiple factors, component 299 optimizes job execution and resource allocation, offering users price rebates for allowing multi-tenant circuit operation. Such improvements may reduce the classical resources required to perform the calculation of the quantum or hybrid algorithm, by improving the capabilities of the quantum system 230.

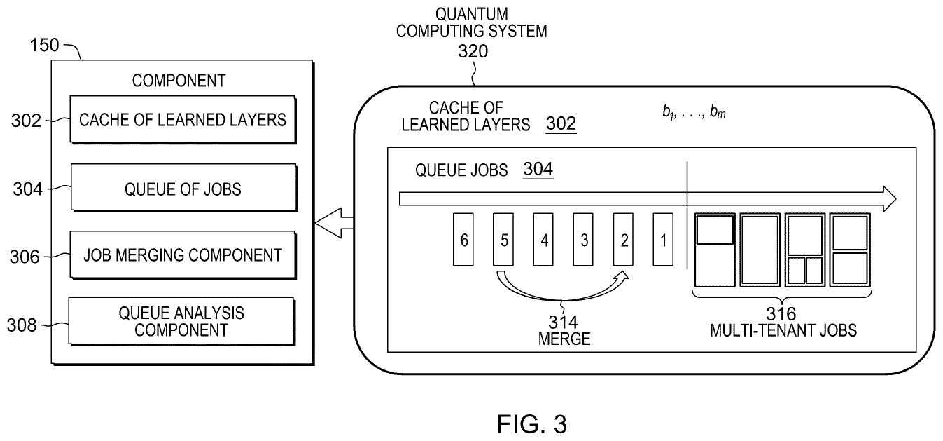

FIG. 3 illustrates block diagram of component 299 in communication with client computer 101, remote server 104, private cloud 106, EUD 103, public cloud 105, quantum system 230, classical backend 220, and/or hybrid computation system 250, within distributed data processing environment 100, for optimizing the efficiency of job execution in a quantum system, in accordance with an embodiment of the present invention. FIG. 3 illustrates one example of a job request from a user through a quantum computing unit. FIG. 3 provides an illustration of one implementation and does not imply any limitations with regard to the environments in which different embodiments may be implemented. Many modifications to the depicted environment may be made by those skilled in the art without departing from the scope of the invention as recited by the claims.

In various embodiments, component 299 optimizes the execution of quantum jobs based on reducing the overhead of error mitigation. The depicted embodiment comprises of component 299 and quantum computing system 320. In the depicted embodiment, component 299 comprises a cache of learned layers 302, queue of jobs 304, job merging component 306, queue analysis component 308. In various embodiments, cache of learned layers 302 comprises b₁, . . . , b_{M}.

Cache of learned layers 302 comprises a set of layers of gates for which the noise model, leveraged in the error mitigation, is known. A layer of gates is represented by a bitstring b∈{0,1}^{N}^{ₑ} where Nₑ is the number of edges in the coupling map. Bit i of the layer of gates b is “0” if b does not have a two-qubit gate on edge i of the coupling map. If edge i does have a two-qubit gate, then bit i in b is “1”. In various embodiments, a job requires a set of layers to run b₁, . . . , b_{M}. In various embodiments, the noise on quantum devices drifts. Therefore, the noise model of each learned layer is only valid for a certain duration before it must be learned again. In various embodiments, the cache has finite size. In various embodiments, the layers that are used often get refreshed at a predetermined time or interval. In various embodiments, layers that become stale are evicted from the cache, which can be based on the duration or validity of the noise model.

Some error mitigation techniques require an understanding of the noise in the QPU. A model of the noise in a QPU is typically generated for the n most frequently occurring layers, wherein “n” is any positive integer. A layer is characterized by the set of used edges on the QPU coupling map and a noise model generated for a layer A is not valid for a layer B unless the layer B uses exactly the same edges on the coupling map as A (it is not sufficient for B to use a subset of edges of A). In a QPU coupling map, edges represent the supported two-qubit operations between qubits. In various embodiments, a coupling map defines which qubits can interact directly with each other via two-qubit gates like controlled NOT (CNOT) gates. The “set of used edges” on a QPU refers to the specific connections, or couplers, between qubits that are actively used during a quantum computation. These edges represent the interactions between qubits, allowing for entanglement and other quantum operations. Edges represent relationships or connections between qubits. These connections, often referred to as couplers, are used to implement two-qubit operations or quantum gates. In various embodiments, edges in the QPU topology define the structure of how qubits interact with each other.

In various embodiments, if a layer C is found in the upcoming stream of jobs such that the combination of layer B and layer C uses exactly the same edges as layer A, then the noise model of A can be reused. This error mitigation technique saves time required for noise learning while still exhibiting a higher result quality available through error mitigation and optimizes circuit placement by identifying, via the coupling technique, which edges of the coupling map are used. In various embodiments, based on the identified edges, component 150 changes the placement of where the quantum program is executed on the QPU which optimizes quantum circuit use.

In the depicted embodiment, queue of jobs 304 comprises a payload that is not compiled and comprises jobs 1-6. In the depicted embodiment, job merging component 306 identifies that jobs 5 and 2 can be merged based on qubit availability and merges 314 job 5 into job 2. In various embodiments, merged jobs share one or more learned layers. In various embodiments, merge 314 produces multi-tenant jobs 316 with a compiled payload.

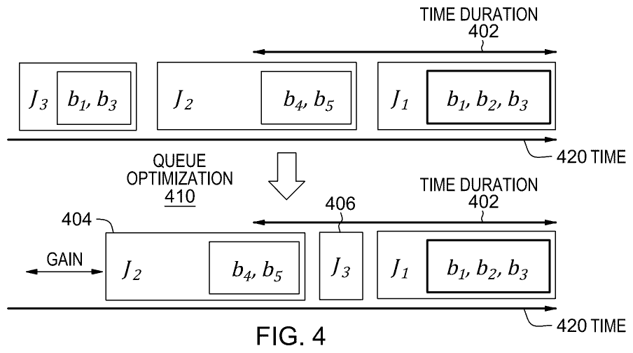

FIG. 4 illustrates an example of queue optimization, in communication with client computer 101, remote server 104, private cloud 106, EUD 103, public cloud 105, quantum system 230, classical backend 220, and/or hybrid computation system 250, within distributed data processing environment 100, in accordance with an embodiment of the present invention. FIG. 4 provides an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, jobs in a queue are reordered based on the cache of learned layers. In other embodiments, jobs in a queue are ordered or reordered in order to create a layer corresponding to a noise model. For example, jobs in the queue are reordered such that the jobs for which the noise model is already known (e.g., learned by a machine learning model) are executed within a predetermined timeframe during which the noise model of the cache of learnt layers is valid.

In various embodiments, component 299 analyzes the circuits in the jobs in the queue. In the depicted embodiment, component 299 analyzes the circuits in each job of the queue to determine the layers of gates for which each job requires a noise model. In various embodiments, component 299 estimates the execution time. In the depicted embodiment, component 299 estimates the execution time of the jobs in the queue. In various embodiments, component 299 adjusts the queue based at least on the analysis, execution time, or current cache of learned layers. In the depicted embodiment, component 299 adjusts the queue by moving jobs forward in the queue that benefit the current cache of learned layers.

For example, the depicted embodiment comprises job 1 (J₁), job 2 (J₂), and job 3 (J₃) in a queue over time 420. In the depicted embodiment, J₃ comprises bitstring b₁ and bitstring b₃, J₂ comprises bitstring b₄ and bitstring b₅, and J₁ comprises bitstring b₁, bitstring b₂, and bitstring b₃. Time duration 402 is the time duration during which the cache is valid and time 420 is the timing associated with the order of the queue. In various embodiments, component 299 identifies that job J₃ can be moved forward in the queue because it only uses a subset of the layers that job J₁ needs (i.e., b₁, b₃ are in the cache). In various embodiments, component 299 reduces the runtime for learning the noise model by reusing the noise model generated in J₁. In various embodiments, the noise model of J₁ is only valid for a certain time (e.g., time duration 402) (i.e. depending on the runtime of J₂ component 150 may not be able to reuse the noise model generated in J₁ for J₃ forfeiting any runtime speedups), thus in this scenario J₃ may jump the queue. For example, in the depicted embodiment, J₃ (block 406) jumps J₂ (block 404) in the queue because bitstring b₁ and bitstring b₃ in J₃ were able to utilize the cache from J₁. In the depicted embodiment, component 299 executes queue optimization 410 based on the analysis and estimate and mergers job J₃ into job J₁.

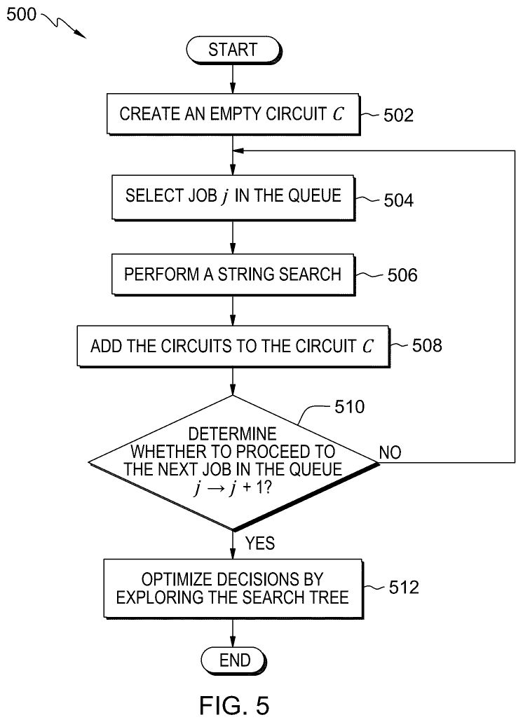

FIG. 5 illustrates operational steps of component 299, generally designated 500, in communication with client computer 101, remote server 104, private cloud 106, EUD 103, public cloud 105, quantum system 230, classical backend 220, and/or hybrid computation system 250, within distributed data processing environment 100, for queue optimization within a quantum system, in accordance with an embodiment of the present invention. FIG. 5 provides an illustration of one implementation and does not imply any limitations with regard to the environments in which different embodiments may be implemented. Many modifications to the depicted environment may be made by those skilled in the art without departing from the scope of the invention as recited by the claims.

In block 502, component 299 creates an empty circuit C. In various embodiments, component 299 creates one or more empty circuit C. In various embodiments, C contains a collection of circuits from various jobs J in the queue. Running C may give the results for one or more jobs in J. In various embodiments, component 299 initializes C in a blank state (i.e. empty) and adds circuits from the queue until the quantum or classical computing budget has depleted or reached a predetermined limit.

In block 504, component 299 selects Job j in the queue. In various embodiments, component 299 selects the next job in the queue and evaluate whether the circuits in that job should be added to C based on user preferences and the reusability of one or more noise models. In various embodiments, component 299 may evaluate the ability to merge jobs in either a time or space-like manner.

In block 506, component 299 performs a string search on the selected jobs from the queue. In various embodiments, component 299 performs a string search to identify where

$${b}_{i}^{j}$$

is contained in layers of the active cache {b₁, . . . , b_{M}}, wherein the identification of

$${b}_{i}^{j}$$

contained in layers of the active cache identifies one or more circuits (e.g., jobs in the queue) that can be added to the full circuit C (e.g., qubit circuit).

In block 508, component 299 adds the one or more circuits identified in block 506 to the full circuit C. In various embodiments, responsive to one or more layers of job j matching the current Cache, component 299 adds the circuits identified in block 506 to the full circuit C. In various embodiments, multiple solutions are retained in a search tree.

In block 510, component 299 determines whether to proceed to the next job in the queue. In various embodiments, component 299 determines whether to proceed to the next job in the queue j→j+1. In the depicted embodiment, if component 299 determines that it cannot proceed to the next job in the queue (Yes Step), then component 299 advances to block 504. In various embodiments, component 299 selects another job in the queue or terminates if merging another job with the current job is not possible (e.g., all the qubits are being used), or the QPU might require a decision on the next circuit to be executed, or user preferences prohibit the merging of jobs. However, in the depicted embodiment, if component 299 determines that it can proceed to the next job in the queue (No Step), then component 299 advances to block 512.

In block 512, component 299 optimizes decisions by exploring the search tree. A search tree is generated depending on where

$${b}_{i}^{j}$$

is contained in layers of the active cache {b₁, . . . , b_{M}}. Each node in the search tree corresponds to a location where

$${b}_{i}^{j}$$

can be contained in the layers of the active cache {b₁, . . . , b_{M}}. Multiple such locations may exist. A location occupied by

$${b}_{i}^{j}$$

cannot be occupied by a subsequent

$${b}_{i}^{′ j} .$$

Therefore, the decisions on where to place the

$${b}_{i}^{j}$$

form a search tree. The end result is a maximization of the number of jobs that can be merged such that the layers of gates they require all fit in the active cache {b₁, . . . , b_{M}}. In various embodiments, a search tree is formed by matching layers in the jobs being considered with the layers in the cache of learned layers. For example, a bitstring

$${b}_{i}^{k}$$

may match in multiple locations of a bit string

$${b}_{i}^{j} .$$

For example,

$${b}_{3}^{1} = “ 1 ”$$

matches at positions 0, 2, and 4 in

$${b}_{1}^{1} = “ 10101 ” .$$

In various embodiments, once a string is matched the position is not reused (e.g., a match denotes a node in the search tree.).

In various embodiments, component 299 scans the queue to identify circuits that can be merged which minimizes the resulting noise layers to learn and/or match the noise layer with those that are in the Cache of learned layers. In various embodiments, circuit merging comprises creating an empty circuit C, selecting Job j in the queue, performing a string search to identify where

$${b}_{i}^{j}$$

is contained in layers of the active cache {b₁, . . . , b_{M}}, adding the circuits to the full circuit C, determining whether to proceed to the next job in the queue. Here,

$${b}_{i}^{j}$$

is the i-th layer of gates needed by the j-th job in the queue. In various embodiments, component 299 determines whether to proceed to the next job in the queue j→j+1, and optimizing decisions by exploring the search tree. In various embodiments, lenient job merging with noise model processing occurs when jobs can be merged but only some of the resulting layers of gates are in the Cache of learned layers and each missing layer is a substring of at least one of the existing layers in the cache of learnt layers. In various embodiments, depending on the available QPU resources, processes such as crosstalk contributing to noise in the QPU, size of the quantum job queue and job priorities, component 299 enables a lenient or strict job merging with or without noise learning.

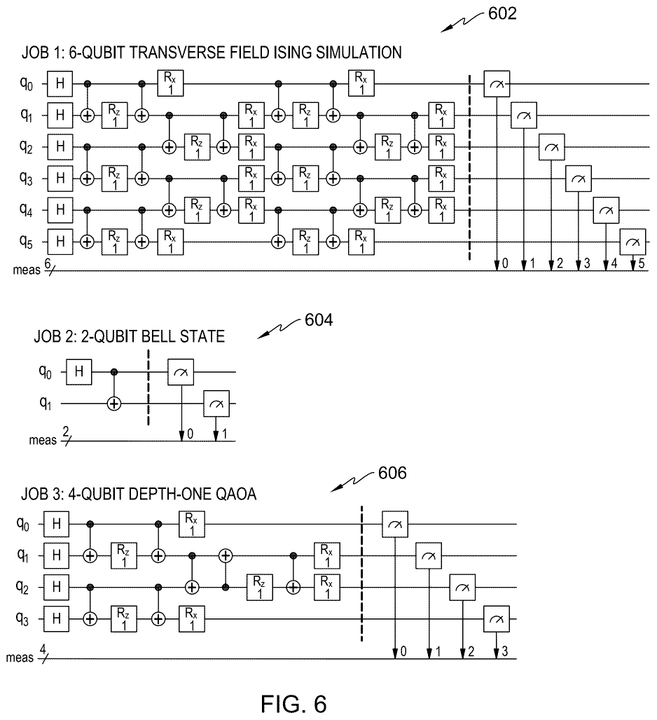

FIG. 6 illustrates an example of queue optimization by job merging in accordance with an embodiment of the present invention. FIG. 6 provides an illustration of one implementation and does not imply any limitations with regard to the environments in which different embodiments may be implemented. Many modifications to the depicted environment may be made by those skilled in the art without departing from the scope of the invention as recited by the claims.

For example, looking at FIG. 6, there is Job 602, hereinafter referred to as “Job1”, a 6-qubit Transverse field Ising simulation, Job 604, hereinafter referred to as “Job2”, a 2-qubit Bell state and Job 606, hereinafter referred to as “Job3”, a 4-qubit depth-one QAOA. In the depicted embodiment, Job1 needs Bitstrings “10101”

$${b}_{1}^{1}$$

and “01010”

$${b}_{2}^{1} ,$$

Job2 needs bitstrings “1”

$${b}_{1}^{2} ,$$

and Job3 needs bitstrings “101”

$${b}_{1}^{3} ,$$

and “010”

$${b}_{2}^{3} .$$

In this example, Job2 can be placed anywhere in C since

$${b}_{1}^{2}$$

can match on (0), (2), or (4) of

$${b}_{1}^{1}$$

or it can match on (1) or (3) of

$${b}_{2}^{1} .$$

Additionally, in this example, Job3 can benefit from the noise models of Job1 because

$${b}_{1}^{3}$$

is contained in

$${b}_{1}^{1}$$

[on indices (0, 1, 2) or (2, 3, 4)], and

$${b}_{2}^{3}$$

is contained in

$${b}_{2}^{1}$$

[on indices (0, 1,2) or (2, 3, 4)], the set of indices on which

$${b}_{i}^{3}$$

match with

$${b}_{i}^{1}$$

have an overlap for i=1, 2 and there are valid solutions in the search tree. In various embodiments, Job2 can be placed anywhere but depending on where Job2 is placed, Job3 may not be able to be placed.

In various embodiments, depending on the available QPU resources, processes such as crosstalk contributing to noise in the QPU, size of the quantum job queue and job priorities, component 299 enables a lenient or strict job merging with or without noise learning. In various embodiments, strict job merging occurs when jobs can only be merged if the resulting layers of gates are exactly in the Cache of learned layers. In various embodiments, strict job merging with noise learning occurs when jobs can be merged but only some of the resulting layers of gates are in the Cache of learned layers. In this case we (i) proceed with the job merging, (ii) learn the missing layers, and (iii) add these newly learnt layers to the cache of learnt layers.

In various embodiments, lenient job merging with noise model processing occurs when jobs can be merged but only some of the resulting layers of gates are in the Cache of learned layers and each missing layer is a substring of at least one of the existing layers in the Cache of learnt layers. For example “01000” is a substring of “01010”. In this example, component 299 may process the noise model of “01010” to derive a noise model for the missing layer “01000”.

In various embodiments, component 299 utilizes machine learning to search bitstring jobs for space to implement job merging. In various embodiments, component 299 utilizes machine learning (ML) to learn a mapping between the bitstring data and the decisions or actions that are made by the search tree. In various embodiments, reinforcement learning models are utilized to learn how to make decisions about the bitstring in order to maximize a reward, based on past interactions or feedback from the environment. In various embodiments, over-time reinforcement learning model (agent) can learn the policy of what bitstring fits better. In various embodiments, component 299 utilizes one or more decision trees or random forest models to learn a decision structure based on features extracted from the bitstring, such as patterns or bit distributions. In various embodiments, the ML model is trained using past results and one or more policies, wherein the past results are labeled on a bitstring. For example, a classifier or a model developed using reinforcement learning based on a reward function and policies. In various embodiments, the ML model is utilized to map between the bitstring data and the decisions or actions that are made by the search tree to optimize the queue and job execution of a quantum computing system.

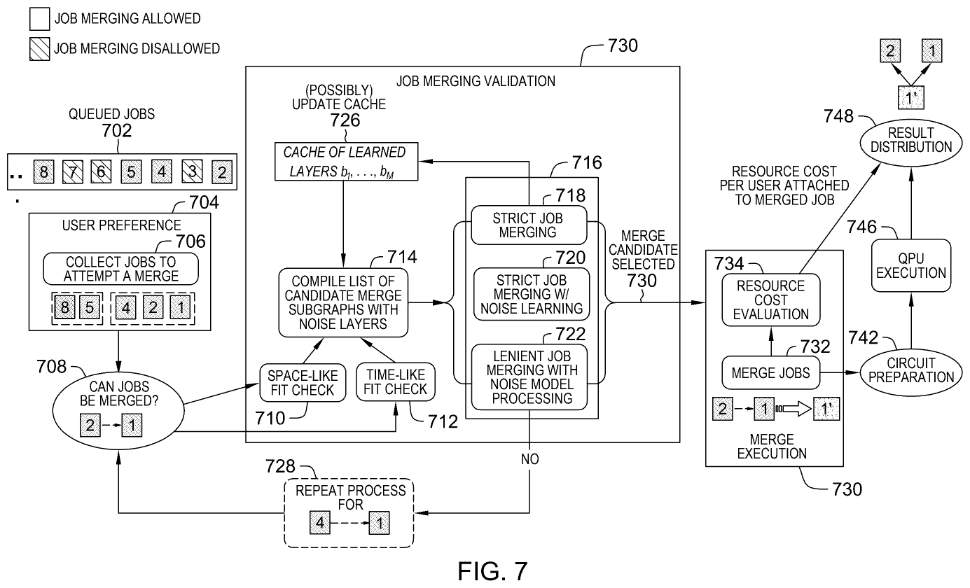

FIG. 7 illustrates operational steps of component 299, generally designated 500, in communication with client computer 101, remote server 104, private cloud 106, EUD 103, public cloud 105, quantum system 230, classical backend 220, and/or hybrid computation system 250, within distributed data processing environment 100, for queue optimization within a quantum system, in accordance with an embodiment of the present invention. FIG. 5 provides an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, queued jobs 702 comprise jobs 1-8. In the depicted embodiment, jobs 8, 5, 4, 2, and 1 have been identified as being mergeable with other jobs. In various embodiment, component 299 retrieves and/or receives user preference 704. In the depicted embodiment, collects jobs 706 from queued jobs 702 based on user preference 707 to attempt to merge the collected jobs. In the depicted embodiment, component 299 attempts to merge job 8 and job 5, and attempts to merge job 4 and/or job 2 with job 1. In various embodiments, component 299 determines if the collected jobs can be merged 708. In the depicted embodiment, component 299 determines whether job 2 can merge with job 1. In the depicted embodiment, component 299 utilizes job merging validation 730 to identify whether jobs can be merged 708.

In the depicted embodiment, component 299 performs space-like fit check 710 and time-like fit check 712 on queued jobs 702 and a quantum computing system. In the depicted embodiment, responsive to performing space-like fit check 710 and time-like fit check 712, component 299, via job merging validation 730, compiles a list 714 of jobs that can potentially merge (candidates). In various embodiments, the list of candidates compiled comprises candidate merge subgraphs with noise layers. The characteristics of the target QPU and job candidates to be executed can give raise to degrees of freedom that can be exploited to improve the throughput of the QPU and potentially the result quality by allowing for more sophisticated error mitigation techniques that make advanced use of noise models. In various embodiments, a space-like check evaluates whether a job candidate can be merged in light of the user preferences and QPU characteristics. For example, two merged jobs may exceed the total number of qubits in a QPU, or user preferences enforce a margin of qubits between merged jobs such that merged job exceeds qubit numbers or a user enforces a specific qubit connectivity that is incompatible with a job merge if a portion of the QPU is used by an already selected job candidate. In various embodiments, a time-like check evaluates whether a job candidate can be merged without increasing the total runtime of the merged job. For example, the current job merge candidate uses qubits Q for time T and qubits K for time S with S<<T, a job with runtime R may be executed on K if S+R<=T.

In the depicted embodiment, component 299 will identify how to merge jobs and/or determine which type merging 716 will be performed on jobs from compiled list 714. In various embodiments, several factors (e.g., user preference analysis, space-like fit, and time-like fit) to compile a list of candidates to merge in subgraph. In various embodiments, the merging being performed is determined based on the size of the queue and cache of learned layers. In various embodiments, if the amount of jobs in a queue exceeds a predetermined threshold or a predetermined number of jobs, then component 299 merges two or more jobs with a more lenient set of merge criteria which maximizes job throughput at the expense of additional noise learning/processing. Alternatively, in various embodiments, component 299 merges two or more jobs with a strict set of merge criteria when the layers of the merged job are present in the cache of learned layers. In the depicted embodiment, jobs can be merged through strict job merging 718, strict job merging with noise learning 720, or lenient job merging with noise model processing 722. In various embodiments, responsive to identifying how to merge two or more selected jobs in the queue, component 299 merges the two or more selected candidates 731 through merge execution 735.

In various embodiments, component 299 determines whether jobs in compiled list 714 can be merged. In various embodiments, if no merge candidate is found (No step) then component repeats the process 728 above for remaining jobs in the queue or that have been collected. In the depicted embodiment, if no merge candidate is found (No step) then component repeats the process 728 above for jobs 4 and 1. In various embodiments, component 299 updates cache 726 when identifying jobs to merge. In the depicted embodiment, component 299 may update cache 726 of the cache of learned layers b₁, . . . , b_{M} and check the compile list against the updated cache.

In the depicted embodiment, component 299 selects one or more candidates to merge an existing job. In various embodiments, component 299 performs merge execution 735. In the depicted embodiment, component 299 merges 732 job 2 with job 1, via merge execution 735, to form job 1′ (i.e., job one prime). In various embodiments, responsive to merging jobs 732, component 299 performs resource cost evaluation 734 and circuit preparation 742. In various embodiments, resource cost evaluation 734 comprises estimating the amount of time that will be billed to the user including possible rebates to incentivize a multi-tenant operation of the QPU. In various embodiments, resource cost evaluation 734 provides an estimation of the time it will take the QPU to execute the merged jobs. In various embodiments, circuit preparation 742 comprises the preparation of the instructions that the control electronics will execute.

In various embodiments, responsive to the merging of two or more jobs, QPU execution 746 of the merged jobs is performed. In the depicted embodiment, responsive to the merging of two or more jobs, QPU execution 746 of job 1′ is performed. In various embodiments, responsive to QPU execution 746 being performed on the merged job, QPU execution 746 outputs the results of the job execution, wherein component 299 performs result distribution 748 of the results. In the depicted embodiment, component 299 performs result distribution 748 of the results from QPU execution of job 1′ so that the results corresponding to job 2 are output separately from the results corresponding to job 1.

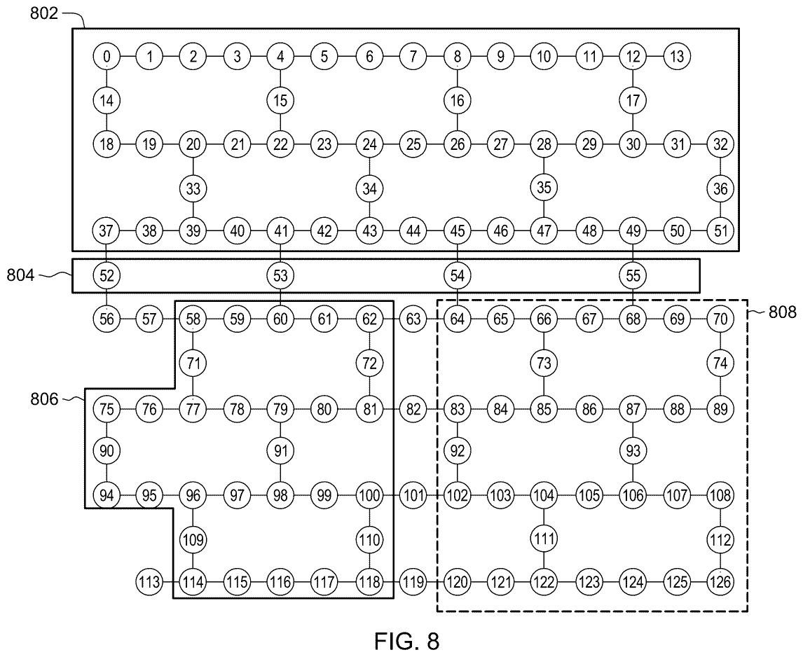

FIG. 8 illustrates an example of queue optimization through space merging in accordance with an embodiment of the present invention. FIG. 8 provides an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, there is a 127-qubit quantum system. In one example, the user of job Jᵢ₊ₖ is willing to execute on any qubits that (i) match the given topology (sparse sub-graph isomorphism problem), (ii) have error rates bounded by X (e.g., measured by γ, EPLG, etc.), and (iii) do not execute on M-distance away neighboring qubits (e.g., M=1). In this example, job Jᵢ requires 52 qubits to be executed and thus transpiled to the first 52 qubits (qubits 802) and job Jᵢ₊ₖ requires 30 qubits to be executed and is re-transpiled to a 30-qubit section 806 of the 127-qubit quantum system. In this example, qubits 52-55 are safety qubits 804 that are utilized to avoid gate and measurement XT, which leaves qubit section 808 open to perform more jobs.

In a different example, displaying time merging utilizing the same depicted embodiment and jobs, Suppose we have merged job Jᵢ₊ₖ into job Jᵢ but the number Mᵢ of shots of job Jᵢ is much larger than the number Mᵢ₊ₖ of shots of job Jᵢ₊ₖ. This leaves a time window for more job merging. Time-like void in the job that can be leveraged to fill more jobs. In various embodiments, when merging Jᵢ₊ₖ we could partially merge into J_{i±1} and Jᵢ if there is not enough time-space in Jᵢ alone. In various embodiments, if there is time-space in the job, we can merge in more jobs based on the cache of learned layers as described previously.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving a plurality of quantum circuits;
determining a noise model for each of the plurality of quantum circuits; and
executing a portion of the plurality of quantum circuits concurrently based on the noise model for each of the plurality of quantum circuits.

2. The method of claim 1, further comprising:
merging two or more jobs in a queue.

3. The method of claim 2, wherein the merging of the two or more jobs comprises:
determining the two or more jobs in the queue can merge based on a size of the queue and a cache of learned layers.

4. The method of claim 1, further comprising:
scanning a queue of jobs in a quantum computing system to identify circuits that can be merged to minimize resulting noise layers to learn or match the noise layers with those that are in a cache of learned layers.

5. The method of claim 1, further comprising:
compiling a list of jobs in a job queue that can potentially be merged together.

6. The method of claim 1, further comprising:
performing result distribution of an output result.

7. The method of claim 1, further comprising:
creating an empty circuit;
selecting a job in a queue; and
performing a string search to identify where a bitstring is contained in layers of active cache.

8. A computer system comprising:
one or more computer processors;
one or more computer readable storage devices; and
program instructions stored on the one or more computer readable storage devices for execution by at least one of the one or more computer processors, the stored program instructions comprising:
program instructions to receive a plurality of quantum circuits;
program instructions to determine a noise model for each of the plurality of quantum circuits; and
program instructions to execute a portion of the plurality of quantum circuits concurrently based on the noise model for each of the plurality of quantum circuits.

9. The computer system of claim 8, further comprising:
program instructions to merge two or more jobs in a queue.

10. The computer system of claim 9, wherein the merging of the two or more jobs comprises:
determining the two or more jobs in the queue can merge based on a size of the queue and a cache of learned layers.

11. The computer system of claim 8, further comprising:
program instructions to scan a queue of jobs in a quantum computing system to identify circuits that can be merged to minimize resulting noise layers to learn or match the noise layers with those that are in a cache of learned layers.

12. The computer system of claim 8, further comprising:
program instructions to compile a list of jobs in a job queue that can potentially be merged together.

13. The computer system of claim 8, further comprising:
program instructions to perform result distribution of an output result.

14. The computer system of claim 8, further comprising:
program instructions to create an empty circuit;
program instructions to select a job in a queue; and
program instructions to perform a string search to identify where a bitstring is contained in layers of active cache.

15. A computer program product comprising:
one or more computer readable storage devices and program instructions stored on the one or more computer readable storage devices, the stored program instructions comprising:
program instructions to receive a plurality of quantum circuits;
program instructions to determine a noise model for each of the plurality of quantum circuits; and
program instructions to execute a portion of the plurality of quantum circuits concurrently based on the noise model for each of the plurality of quantum circuits.

16. The computer program product of claim 15, further comprising:
program instructions to merge two or more jobs in a queue, wherein the merging of the two or more jobs comprises:
determining the two or more jobs in the queue can merge based on a size of the queue and a cache of learned layers.

17. The computer program product of claim 15, further comprising:
program instructions to scan a queue of jobs in a quantum computing system to identify circuits that can be merged to minimize resulting noise layers to learn or match the noise layers with those that are in a cache of learned layers.

18. The computer program product of claim 15, further comprising:
program instructions to compile a list of jobs in a job queue that can potentially be merged together.

19. The computer program product of claim 15, further comprising:
program instructions to perform result distribution of an output result.

20. The computer program product of claim 15, further comprising:
program instructions to create an empty circuit;
program instructions to select a job in a queue; and
program instructions to perform a string search to identify where a bitstring is contained in layers of active cache.
